(19) United States
(12) Patent Application Publication
(10) Pub. No.: US 2018/0334298 A1
(43) Pub. Date: Nov. 22, 2018

(54) TWISTABLY CLOSEABLE FLEXIBLE PACKAGING LAMINATE

(71) Applicant: Transcontinental Multifilm Inc., Elgin, IL (US)

(72) Inventor: Christopher J. Rogers, Crystal Lake, IL (US)

(21) Appl. No.: 15/974,875

(22) Filed: May 9, 2018

Related U.S. Application Data
(60) Provisional application No. 62/507,535, filed on May 17, 2017.

(51) Int. Cl. B65D 65/14; B65D 75/26

(52) U.S. Cl. CPC B65D 65/14; B65D 75/26; B32B 2439/70; B32B 2311/24; B32B 2323/10; B32B 2323/04; B32B 2367/00

(57) ABSTRACT

A multilayer film for use in making packaging. The film includes a first layer including a heat resistant polymer, a second layer including adhesive and a material configured to form a dead fold, and a third layer including a sealable polymer.

### RELATED APPLICATION

This application makes reference and claims priority to U.S. Provisional Patent Application No. 62/507,535, filed on May 17, 2017 and titled “Twistably Closeable Flexible Packaging Laminate.” U.S. Provisional Patent Application No. 62/507,535 is hereby incorporated herein in its entirety.

### BACKGROUND OF THE INVENTION

The present technology relates to flexible packaging, and, in particular, a film or laminate for flexible packaging for food items.

Conventional wrappers, pouches, and packaging made for food items like candy bars, nuts, and granola bars are typically made of flexible material, such as a polymer film, that is sealed at the top and bottom ends and along a rear seam to seal the food inside. Examples of such methods of making packaged foods include flow wrap techniques and vertical form fill seal techniques.

Often times, a consumer will not eat all of the food inside such a wrapper or packaging at one time. Thus, it is not uncommon for a consumer to tear open an end of the wrapper of, for example, a granola bar, eat a portion of the granola bar, and then leave the uneaten portion of the granola bar in the wrapper. Once the wrapper has been torn open, however, the consumer cannot re-seal the torn end of the wrapper or otherwise easily close off the opening in the wrapper without the wrapper re-opening on its own. This can result in the uneaten food in the wrapper falling out of the unclosed wrapper or being exposed to contaminants.

### SUMMARY

Certain aspects of the present technology provide a multilayer film for use in making packaging. The film includes a first layer including a first polymer, a second layer including adhesive and a material configured to form a dead fold, and a third layer including a sealable second polymer.

The material configured to form a dead fold can be aluminum. The aluminum can be positioned between layers of adhesive in the second layer. The aluminum can extend for less than half of the width of the film. The aluminum can include at least two individual strips. The first layer can be transparent and the aluminum can be opaque. The first layer can be a heat resistant material and be one of polypropylene and polyester, and the third layer can be a heat sealable material and be one of polyethylene and polypropylene.

Certain aspects of the present technology provide packaging for food. The packaging includes a wrapper made from a laminate film. The wrapper has a front side, a back side, and first and second ends, and the wrapper includes seals along the back side and along the first and second ends. At least a portion of the wrapper is generally transparent and at least a portion of the wrapper is made of material configured to form a dead fold. After the wrapper has been opened, the wrapper can be twisted closed and is generally retained in the twistedly closed position by the material configured to form a dead fold.

The film can include a first layer including a heat resistant polymer, a second layer including adhesive and the material configured to form a dead fold, and a third layer including a heat sealable polymer. The material configured to form a dead fold can be aluminum. The aluminum can be positioned between layers of adhesive in the second layer. The aluminum can extend for less than half of the width of the film. The aluminum can include at least two individual strips of aluminum. The first and third layers can be transparent and the aluminum in the second layer can be opaque. The first layer can be one of polypropylene and polyester, and the third layer can be one of polyethylene and polypropylene.

Certain aspects of the present technology provide packaging for food. The packaging includes a film including a first layer including a transparent heat resistant polymer, a second layer including transparent adhesive and opaque aluminum portions at first and second ends of the layer, and a third layer including a transparent heat sealable polymer. The film is formed and sealed about contents to form a wrapper having a front side, a back side, and first and second ends. The wrapper includes seals along the back side and the first and second ends. At least a portion of the front side of the wrapper is transparent, and at least a portion of the back side of the wrapper includes the opaque aluminum portions. After the wrapper has been opened, the wrapper can be twisted closed and is generally retained in the twistedly closed position by the aluminum portions. The aluminum can extend for less than half of the width of the film.

### BRIEF DESCRIPTION OF THE DRAWINGS

FIG. 1 illustrates a top view of a portion of a web of laminated film according to an embodiment of the present technology.

FIG. 2 illustrates a top view of wrapper packaging containing food according to an embodiment of the present technology.

FIG. 3 illustrates a bottom view of the wrapper packaging of FIG. 2.

FIG. 4 illustrates an enlarged cross-sectional side view of the laminated film of FIG. 1 taken along lines 4-4.

FIG. 5 illustrates a top view of the wrapper packaging of FIG. 2 after it has been opened and a portion of its contents removed.

FIG. 6 illustrates a top view of the wrapper packaging of FIG. 5 after it has been twisted closed.

The foregoing summary, as well as the following detailed description of certain embodiments of the present technologies, will be better understood when read in conjunction with the appended drawings. For the purpose of illustrating the technologies, there is shown in the drawings, certain embodiments. It should be understood, however, that the present technologies are not limited to the arrangements and instrumentality shown in the attached drawings.

### DETAILED DESCRIPTION

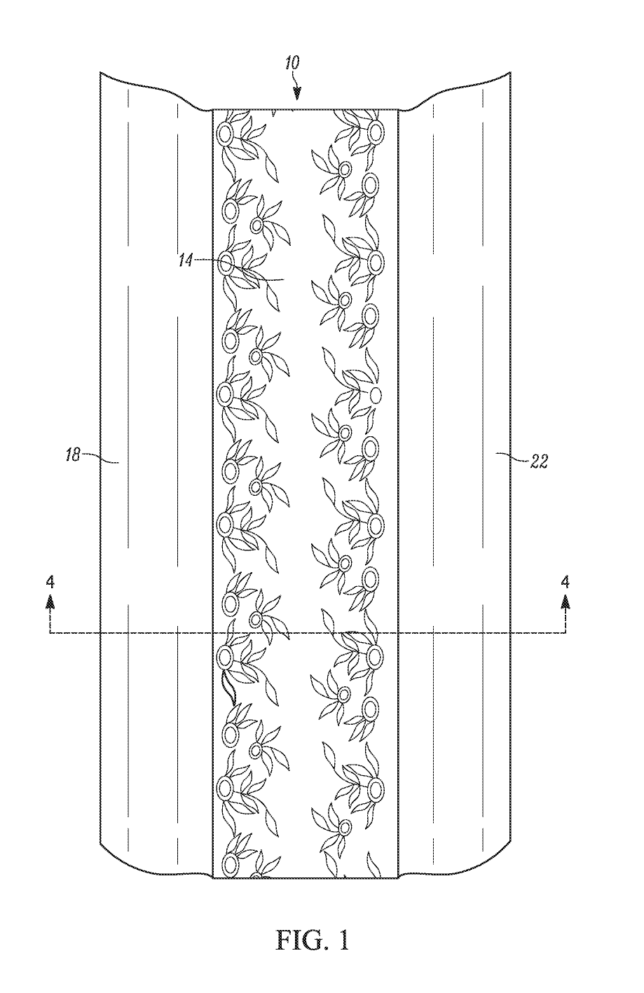

FIG. 1 illustrates a top view of a portion of a web of laminated film 10 that can be used to make packaging or wrappers for food items. The film 10 includes a generally transparent center portion 14 surrounded on each side by opaque side portions 18 and 22. The transparent center portion 14 may include print, images, and/or other indicia thereon. The side portions 18 and 22 may be metallic in appearance, but also may have other colors or appearances, and also may also include print, images, and/or other indicia thereon. The web of film 10 is laminated and may be formed in rolls. By way of example, a roll of the film 10 may be 4-6 inches wide and thousands of feet long.

The film 10 is used to form packaging, such as wrappers or pouches, for food items. By way of example only, the film 10 can be used to form packaging for things like candy pieces, gummy candy, candy bars, nuts, granola bars, and chocolate. The packaging process involves forming discrete portions of the web of film 10 around a portion of food, or forming discrete portions of the web of film 10 into a tube shape and then filling the tube-shaped film portion with a portion of food. The film 10 is then sealed about the food (for example, by a heat sealing process along the ends and rear of the tube) to form a discrete package. Alternatively, the film 10 could be cold sealed. The package is then separated from adjacent portions of film in the web. By way of example, the web of film 10 can be used to package food in a flow wrap or vertical form fill seal process.

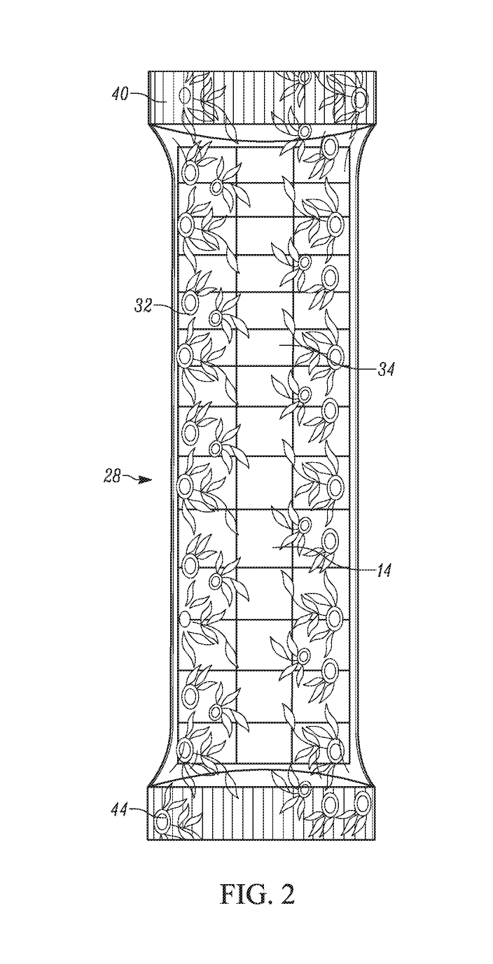

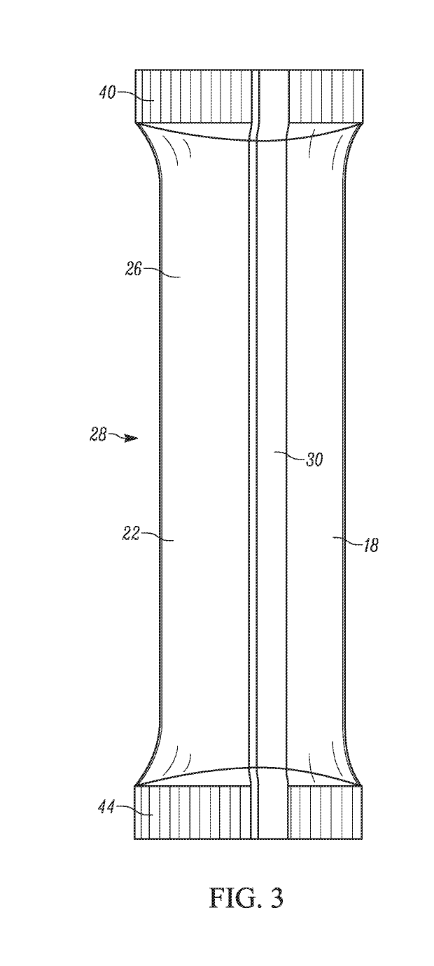

FIGS. 2 and 3 illustrate top (or front) and bottom (or rear) views, respectively, of an individual wrapper or package 28 made from the film 10 of FIG. 1 and containing a candy bar 34. A front portion 32 of the wrapper 28 is formed from the transparent center portion 14 of the film 10. A rear portion 26 of the wrapper 28 is formed by the two opaque side portions 18 and 22 of the film 10. Inner sides of the side portions 18 and 22 of the film 10 are sealed together as part of the packaging process. By way of example, they could be heat sealed or cold sealed or sealed in other known ways. As shown in FIG. 3, the seal 30 is located along the rear portion 26 of the wrapper 28. The wrapper 28 also has ends 40 and 44 that are sealed together along their inner sides during the packaging process. By way of example, they could be heat sealed or cold sealed or sealed in other known ways. In this way, the candy bar 34 is sealed within the wrapper 28, and a consumer can see the front of the candy bar through the transparent front portion 32 of the wrapper 28.

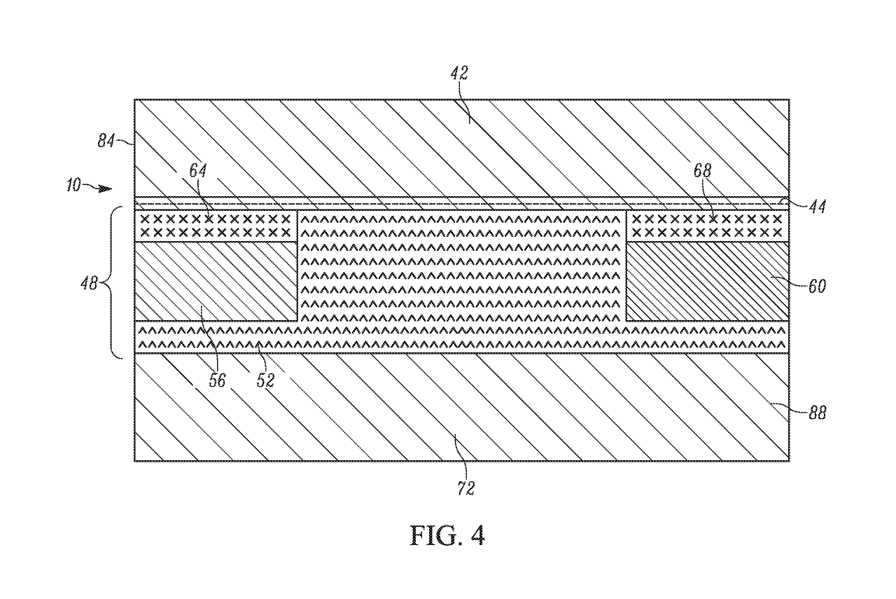

FIG. 4 illustrates a cross-sectional side view of the laminate film 10 of FIG. 1. The film 10 includes a first layer 42 that serves as the outer layer of the packaging formed from the film 10. The first layer 42 is preferably flexible material and may be a heat resistant material. By way of example only, the first layer 42 may be a polyester or polypropylene material with a thickness of approximately 0.5 mils to 1.0 mils, but other suitable materials and thicknesses may also be used. The first layer 42 may also include printing inks 44 that can be used to provide decorations, print, and/or indicia on the packaging. The film 10 further includes a middle or second layer 48 that includes a full width adhesive layer 52, an aluminum material in the form of two aluminum foil strips 56 and 60, and two thin adhesive strip layers 64 and 68. The adhesive layers 52, 64, and 68 can be made of any number of suitable adhesive materials. By way of example, the second layer may have a thickness of approximately 0.30 mils to 0.65 mils, and the aluminum strips 56 and 60 each have a thickness of approximately 0.25 mils to 0.50 mils. The film 10 also includes a third layer 72 that serves as the inner layer of the packaging formed from the film 10 and that is in contact with the food in the packaging. The third layer 72 is preferably a flexible, heat sealable material. Alternatively, the third layer 72 may be a material that can be sealed by a cold sealing process. By way of example only, the third layer 72 may be a polypropylene or polyethylene material with a thickness of approximately 0.5 mils to 2.0 mils, but other suitable coatings or polymer materials that are sealable (by heat sealing or otherwise) may be used and other thicknesses may also be used.

The aluminum foil strips 56 and 60 are located at opposite ends of the film 10, and the full-width adhesive layer 52 is located between and underneath the aluminum foil strips 56 and 60 and extends between the third layer 72 and a portion of the first layer 42. The two thin adhesive strips 64 and 68 are located between the tops of the aluminum foil strips 56 and 60 and the bottom of portions of the first layer 42 and serve to adhere the foil strips 56 and 60 to the first layer 42. The full width adhesive layer 52 adheres the first layer 42 and the bottoms of the foil strips 56 and 60 to the third layer 72. Alternatively, the middle layer 48 may include a single aluminum foil strip or may include more than two aluminum foil strips. The aluminum foil strip(s) of the middle layer 48 may extend along a greater or lesser portion of the width of the film 10 than that shown in FIG. 4. By way of example only, the aluminum foil strip(s) of the middle layer 48 may cumulatively extend somewhere in the range of 40% to 70% of the width of the film 10. The aluminum foil strips 56 and 60 are generally opaque (and may have a metallic appearance) while the first and third layers 42 and 72 and the full-width adhesive layers 52, 64, and 68 are generally clear or transparent (except for the printing inks 44 that may be on the first layer 42). Alternatively, either or both of the first (outside) layer 42 and third (or inside) layer 72 can be a metallized film, or any other opaque film, such as a white one.

When the film 10 is used to make packaging for food, a portion of the film 10 is wrapped around a food item, or formed into a tube shape to receive a food item, with the third layer 72 serving as the inner layer of the packaging and the first layer 42 serving as the outer layer of the packaging. Side ends 84 and 88 of the film 10 are joined together by heat sealing the third (or inner) layer 72 to itself at the ends 84 and 88 to form the rear seal 30 (FIG. 3). Because the first (or outer) layer 42 is more heat resistant than the third layer 72, the outer layer 42 does not melt during the heat sealing process. The ends 40 and 44 (FIGS. 2 and 3) of the packaging are likewise sealed by heat sealing the inner layers 72 of the ends 40 and 44 to each other. Alternatively, the sealing may be done by cold sealing or other sealing processes that do not use heat. In such cases, the first layer 42 may not be made of a heat resistant material and the third layer 72 may not be made of a material that is heat sealable.

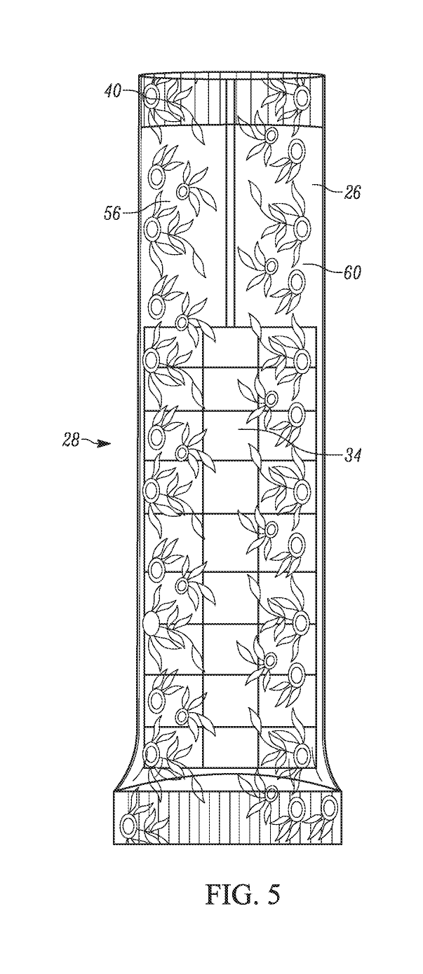

In operation, the aluminum foil strips 56 and 60 help in closing, and keeping closed, the wrapper 28 from which they are made. FIG. 5 illustrates a top (or front) view of an individual wrapper 28 made from the film 10 of FIG. 1 after the wrapper 28 has been opened at the top end 40 and a portion of the candy bar 34 in the wrapper 28 has been removed. The wrapper 28 has been opened by tearing open or unsealing the top end 40 of the wrapper 28. The foil strips 56 and 60 in the rear portion 26 of the wrapper 28 can be seen where a portion of the candy bar has been removed.

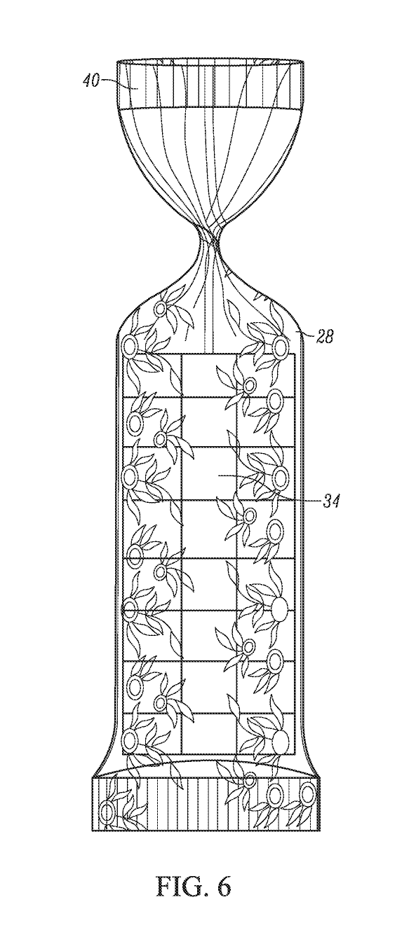

As shown in FIG. 6, after the consumer has removed a portion of the candy bar 34 from the wrapper 28, the consumer can then twist the portion of the wrapper 28 from which food has been removed to close off the wrapper 28. Because the aluminum foil strips 56 and 60 (FIG. 4) that are part of the rear portion 26 (FIG. 3) of the wrapper 28 retain their shape after being deformed, i.e., they have good memory and form dead folds, the wrapper 28 generally stays twisted as shown in FIG. 6 until some outside force untwists it. In this way, the wrapper 28 can be re-closed and stay re-closed after a portion (but not all) of the food in the wrapper 28 has been removed. Thus, the wrapper 28 can be re-closed to help prevent the remaining food from falling out of the wrapper 28, even when the wrapper 28 is turned upside down with the twist-closed end 40 on the bottom. The re-closed wrapper 28 can also help prevent exterior items from getting into the re-closed wrapper 28 and mixing with or contaminating the remaining food. Once the consumer wishes to finish off the remaining food in the wrapper 28, the consumer can easily untwist the wrapper 28 and remove the remaining food through the open top end 40.

In an alternative embodiment, the aluminum or aluminum foil strips 56 and 60 could be replaced with another material that has good flexibility and memory and that can keep the shape of the packaging when it is twisted closed, i.e., form a dead fold.

It is to be understood that the invention is not limited in its application to the details of construction and the arrangement of the components set forth in the description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

While various spatial and directional terms, such as top, bottom, lower, mid, lateral, horizontal, vertical, front and the like may used to describe embodiments of the present invention, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention.

1. A multilayer film for use in making packaging, comprising:
a first layer comprising a first polymer;
a second layer comprising adhesive and a material configured to form a dead fold; and
a third layer comprising a second polymer that is sealable.

2. The multilayer film of claim 1, wherein the material configured to form a dead fold is aluminum.

3. The multilayer film of claim 2, wherein the aluminum is positioned between layers of adhesive in the second layer.

4. The multilayer film of claim 2, wherein the aluminum extends for less than half of the width of the film.

5. The multilayer film of claim 4, wherein the aluminum comprises at least two individual strips.

6. The multilayer film of claim 5, wherein the first layer is transparent and the aluminum is opaque.

7. The multilayer film of claim 1, wherein the first layer is heat resistant and one of polypropylene and polyester.

8. The multilayer film of claim 1, wherein the third layer is heat sealable and is one of polyethylene and polypropylene.

9. Packaging for food, comprising:
a wrapper made from a laminate film, the wrapper having a front side, a back side, and first and second ends, wherein the wrapper includes seals along the back side and along the first and second ends, and
wherein at least a portion of the wrapper is generally transparent and at least a portion of the wrapper is made of material configured to form a dead fold; and
wherein after the wrapper has been opened, the wrapper can be twisted closed and is generally retained in the twistedly closed position by the material configured to form a dead fold.

10. The packaging of claim 9, wherein the film includes a first layer comprising a heat resistant polymer, a second layer comprising adhesive and the material configured to form a dead fold, and a third layer comprising a heat sealable polymer.

11. The packaging of claim 10, wherein the material configured to form a dead fold is aluminum.

12. The packaging of claim 11, wherein the aluminum is positioned between layers of adhesive in the second layer.

13. The packaging of claim 11, wherein the aluminum extends for less than half of the width of the film.

14. The packaging of claim 13, wherein the aluminum comprises at least two individual strips of aluminum.

15. The packaging of claim 14, wherein the first and third layers are transparent and the portions of the second layer including the aluminum is opaque.

16. The packaging of claim 9, wherein the first layer is one of polypropylene and polyester.

17. The packaging of claim 9, wherein the third layer is one of polyethylene and polypropylene.

18. Packaging for food, comprising:
a film including a first layer comprising a transparent heat resistant polymer, a second layer comprising transparent adhesive and opaque aluminum portions at first and second ends of the layer, and a third layer comprising a transparent heat sealable polymer;
wherein the film is formed and sealed about contents to form a wrapper having a front side, a back side, and first and second ends, wherein the wrapper includes seals along the back side and the first and second ends, and
wherein at least a portion of the front side of the wrapper is transparent and at least a portion of the back side of the wrapper includes the opaque aluminum portions; and
wherein after the wrapper has been opened, the wrapper can be twisted closed and is generally retained in the twistedly closed position by the aluminum portions.

19. The multilayer film of claim 18, wherein the aluminum extends for less than half of the width of the film.
